(19) United States
(12) Patent Application Publication
(10) Pub. No.: US 2026/0175230 A1
(43) Pub. Date: Jun. 25, 2026

(54) HAMMERMILL AND HAMMER ASSEMBLY WITH REPLACEABLE HAMMER ELEMENTS

(71) Applicant: CPM Acquisition Corp., Waterloo, IA (US)

(72) Inventors: Heath Hartwig, Cedar Falls, IA (US); Thomas Kanaby, Romney, IN (US); Donovan Mills, Stillwater, OK (US); Todd R. Wolf, Cedar Falls, IA (US)

(73) Assignee: CPM Acquisition Corp., Waterloo, IA (US)

(21) Appl. No.: 19/431,317

(22) Filed: Dec. 23, 2025

Related U.S. Application Data
(60) Provisional application No. 63/738,707, filed on Dec. 24, 2024.

(51) Int. Cl. B02C 13/28

(52) U.S. Cl. CPC B02C 13/2804; B02C 2013/2808

(57) ABSTRACT

A hammer assembly for a hammermill includes a housing defining an interlock-shaped slot and removable and replaceable hammer elements. The hammer elements include complimentary-shaped mounting portions that slide into the slot. The hammer elements may be removably retained in the slot by a fastener, such as a key that slides into the slot and engages the mounting portions of the hammer elements.

### REFERENCE TO RELATED APPLICATION

This application claims the benefit of U.S. Provisional Application No. 63/738,707, filed Dec. 24, 2025, and entitled Hammermill Hammer Assembly With Replaceable Hammer Elements, which is incorporated herein by reference in its entirety for all purposes.

### FIELD

This disclosure relates generally to hammermills and hammers or hammer assemblies for hammermills. Embodiments include a hammer assembly with replaceable hammer elements.

### BACKGROUND

Hammermills and hammer assemblies for use with the hammermills are generally known and disclosed, for example, in the following references:
U.S. Pat. No. 2,568,077
U.S. Pat. No. 2,534,301
U.S. Pat. No. 4,352,774
U.S. Pat. No. 10,486,160
U.S. Patent Application Publication 2021/0121893
PCT International Publication WO 2014/137818

The heads, hammer elements or tips of the hammer assemblies are subject to wear during operation of the hammermills. As shown for example in the above references, the hammer assemblies can be configured with replaceable hammer elements, heads or tips.

There remains, however, a continuing need for improved hammermills, associated hammer assemblies, and associated hammer assembly components such as hammer elements. In particular, there is a need for improved hammer assemblies with replaceable components. For example, there is a need for hammer assemblies with hammer components that can be securely mounted and efficiently replaced. Hammer assemblies of these types that can be efficiently manufactured would be desirable.

### SUMMARY

Disclosed embodiments include a hammermill hammer assembly with hammer elements that can be efficiently replaced and securely mounted.

One example is a hammer assembly for a hammermill. The hammer assembly comprises a housing, one or more hammer elements, and one or more fasteners. The housing may include a mount portion configured for attachment to a drive, and a slot. The hammer elements may include a mount portion configured to removably engage the slot, and a head. The fasteners releasably secure the one or more hammer elements to the mount portion of the housing.

In some embodiments the mount portion of the housing defines a swing axis, and the slot defines a longitudinal axis with respect to the swing axis. The longitudinal axis is optionally generally perpendicular to or parallel to the swing axis.

In some embodiments the mount portion of the housing comprises one or more links, and an aperture in each of the one or more links. For example, embodiments may comprise a plurality of the links.

The slot may be defined by a length, and the plurality of links may define a length that is less than or equal to the length of the slot.

In any or all of the above embodiments, the one or more fasteners engages the mount portion of the housing and the mount portion of each of the one or more hammer elements. For example the one or more fasteners may include a key in the slot. In embodiments, the housing, hammer elements and key are configured such that the key can slide into the slot in a direction parallel to a longitudinal axis of the slot.

In embodiments, the slot is defined by a cross-sectional shape including a first width dimension at a first location with respect to the mount portion, and a second width dimension that is less than the first width dimension at a second location opposite the first location from the mount portion, and the mount portion of each hammer element defines a cross-sectional shape that is complimentary to the cross-sectional shape of the slot, facilitating slidable insertion and the removable engagement of the mount portion of the hammer element in the slot. In embodiments, for example, the cross-sectional shape of the slot and the cross-sectional shape of the mount portion of each hammer element are interlocking shaped.

In some embodiments, the slot includes a base surface, each hammer element includes a base edge, and the key is located between the base surface of the slot and the base edge of each hammer element.

The key may include a base surface that engages the base surface of the slot, an engaging surface opposite the base surface, and wherein the engaging surface is non-parallel to the base surface. In some embodiments the base surface of each hammer element is parallel to and engages the engaging surface of the key.

Some embodiments further comprise a shim between the engaging surface of the key and the base edge of each hammer element.

In some embodiments the one or more fasteners includes one or more fasteners extending through the mount portion of the housing and engaging the key. For example, at least one of the one or more fasteners extending through the mount portion may comprise a threaded fastener.

In some embodiments the one or more fasteners includes one or more fasteners extending through the mount portion. For example, at least one of the one or more fasteners extending through the mount portion comprises a threaded fastener.

Another example includes hammer elements configured for use with a hammer assembly of any or all of the embodiments above.

Yet another example is a hammermill including one or more hammer assemblies in accordance with any or all of the embodiments above.

Another example is a hammermill hammer element configured to be removably mounted to a housing including a slot defining a cross sectional shape. The hammermill hammer element may comprise a mounting portion having a cross sectional shape that is complimentary to the cross sectional shape of the slot of the housing, and configured to slide into the slot and to interlock with the housing, and a head extending from the mounting portion.

### BRIEF DESCRIPTION OF THE DRAWINGS

FIG. 1A is an isometric illustration of a hammermill hammer assembly in accordance with embodiments.

FIG. 1B is an end view of the hammer assembly shown in FIG. 1A.

FIG. 1C is a side view of the hammer assembly shown in FIG. 1A.

FIG. 2A is an isometric view of a housing for a hammermill hammer assembly, such as the hammer assembly shown in FIG. 1A, in accordance with embodiments.

FIG. 2B is an end view of the housing shown in FIG. 2A.

FIG. 2C is a side view of the housing shown in FIG. 2A.

FIG. 3A is an isometric view of a hammer element for a hammermill hammer assembly, such as the hammer assembly shown in FIG. 1A, in accordance with embodiments.

FIG. 3B is an end view of the hammer element shown in FIG. 3A.

FIG. 3C is a side view of the hammer element shown in FIG. 3A. FIG. 4A is an isometric view of a spacer for a hammermill hammer assembly, such as that shown in FIG. 1A, in accordance with embodiments.

FIG. 4B is an end view of the spacer shown in FIG. 4A.

FIG. 4C is a side view of the spacer shown in FIG. 4A.

FIG. 5A is an isometric view of a key for a hammermill hammer assembly, such as that shown in FIG. 1A, in accordance with embodiments.

FIG. 5B is an end view of the key shown in FIG. 5A.

FIG. 5C is a side view of the key shown in FIG. 5A.

FIG. 6 is an exploded isometric view of a hammermill hammer assembly, such as that shown in FIG. 1A, in accordance with embodiments.

FIG. 7 is an isometric view of a partially assembled hammermill hammer assembly, such as that shown in FIG. 1A, in accordance with embodiments.

FIG. 8 is an isometric view of a housing for a hammermill hammer assembly, in accordance with embodiments.

FIG. 9 is an isometric view of a hammermill hammer assembly including a spacer block and shim, in accordance with embodiments.

FIG. 10 is an isometric view of a spacer block and shim for a hammermill hammer assembly, such as that shown in FIG. 9, in accordance with embodiments.

FIG. 11 is an isometric view of a hammer cluster for a hammermill hammer assembly, such as that shown in FIG. 9, in accordance with embodiments.

FIG. 12 an isometric view of a hammermill hammer assembly including an external spacer, in accordance with embodiments.

FIG. 13 is an end view of a hammermill hammer assembly including an external spacer, such as that shown in FIG. 12, in accordance with embodiments.

FIG. 14 is an isometric view of an external spacer for a hammermill hammer assembly, such as that shown in FIG. 12

FIGS. 15A and 15B are isometric and end views, respectively of a key for a hammermill hammer assembly, in accordance with embodiments, including a surface with compliant material.

FIG. 16 is an isometric view of a key for a hammermill hammer assembly, in accordance with embodiments, including recesses.

FIG. 17 is an illustration of a hammermill including hammer assemblies, in accordance with embodiments.

FIG. 18 is an isometric view of a cluster of hammer elements, including a rod, in accordance with embodiments.

FIG. 19 is an isometric illustration of a hammer assembly in accordance with embodiments.

FIG. 20 is an isometric illustration of a hammer assembly in accordance with embodiments.

FIG. 21 is an isometric illustration of a hammer assembly in accordance with embodiments.

FIG. 22 is an isometric illustration of a housing for a hammermill hammer assembly, such as the hammer assembly shown in FIG. 21, in accordance with embodiments.

### DETAILED DESCRIPTION

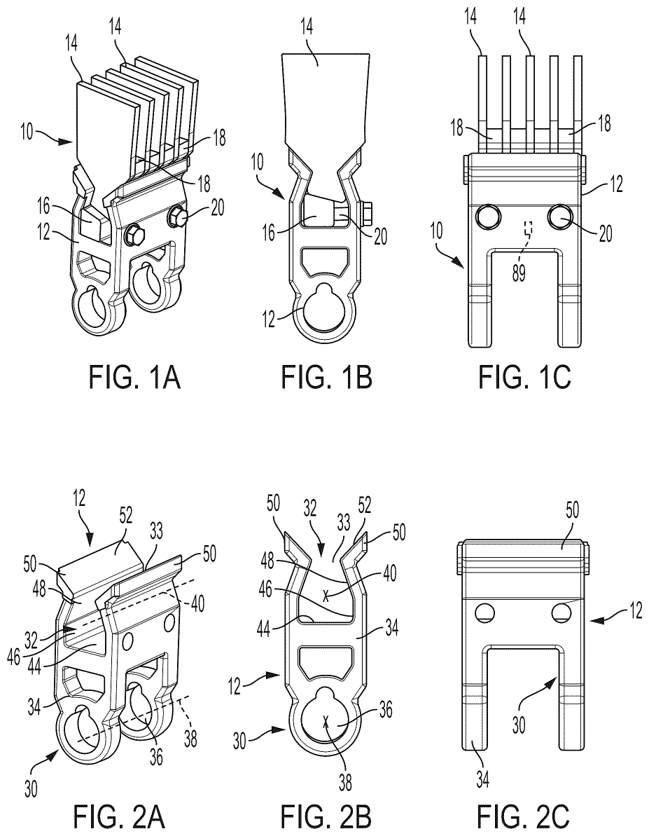

FIG. 1A-1C are illustrations of a hammermill hammer assembly 10 in accordance with embodiments. An exemplary hammermill 400 including hammer assemblies such as 10 is shown in FIG. 17 and described below. The hammer assembly 10 is an assembly that includes a housing 12, one or more (a plurality are shown) of hammer elements 14, and a key 16. Embodiments of hammer 10 such as those shown in FIGS. 1A-1C also include one or more (a plurality are shown) of spacers 18 and one or more (two are shown) bolts 20. As described below, the hammer elements 14 can be efficiently and securely mounted to, and/or removed from the housing 12, thereby facilitating replacement of the hammer elements when they are worn. Hammermill hammer assembly 10 can therefore be efficiently and effectively used. Moving attachment of the hammer elements outside of the rotor plate or other drive components provides for more efficient and effective access and reduction of consumable material. The design provides features including orientation determination, a swing limiting bumper, and strain control.

Referring also to FIG. 2A-2C, the housing 12 includes a body or structure defining a mount portion 30 on a proximal end and a slot 32 on a distal end. Mount portion 30 is configured for attachment of the housing 12 to a rod, disk, rotor plate or other drive structure of a hammermill as shown, for example, in FIG. 17. In particular, the mount portion 30 is configured to be mounted to the hammermill drive structure in such a manner that the hammer assembly 10 can swing, for example rotate or pivot, with respect to the drive structure when the hammermill is in operation. The mount portion 30 can be configured to be mounted for swinging motion to any known or otherwise conventional drive structures, and in the illustrated embodiments include one or more connecting legs or links 34 extending from the portion defining the slot 32, and apertures 36 through end portions of the links (two links are shown for purposes of example in FIGS. 1A, 1C, 2A and 2C). As shown, the apertures 36 define a rotational axis 38 about which the hammer assembly 10 can swing during operation of the hammermill. The links 34 extend from the opposite ends of the portion of the body defining the slot 32 in the embodiments shown in FIGS. 1A-1C and 2A-2C. In other embodiments (not shown), the links extend from portions of the body defining the slot 32 at locations spaced toward the center of the body from the opposite ends.

The slot 32 extends from and between the opposite ends of the body forming the mount portion 30, and has an opening 33 that opens toward the distal end of the housing 12 (e.g., opposite the mount portion). In the illustrated embodiment the slot 32 is open at both opposite ends of the housing 12. In other embodiments (not shown), the slot 32 may open in only one of the ends of the housing 12. The slot 32 is elongated in the illustrated embodiments, and defines a slot axis 40. Slot axis 40 is parallel to the rotational axis 38 in the illustrated embodiments. Slot 32 is configured to removably receive the hammer elements 14 from one or both ends of the housing 12, for example in a direction that is generally axial or parallel with respect to the rotational axis 38, and to help retain the hammer elements in the housing. In the illustrated embodiments, the structure of the mount portion 30 is configured to prevent movement of the hammer elements 14 from the housing 12 in the distal direction, away from the mounting portion 30. Consistent with this functionality, the illustrated embodiments of the slot 32 have an interlocking cross-sectional structure and/or shape (e.g., as shown for example in FIG. 2B, and which may, for example, be similar to a dovetail). The slot 32 is defined by surfaces in the housing 12 including a base surface 44, a pair of relatively proximal side surfaces 46 that extend from opposite sides of the base surface, and a pair of relatively distal side surfaces 48 that extend from the side surfaces 46 toward the opening 33. In the illustrated embodiments the proximal side surfaces 46 extend generally perpendicularly from the base surface 44, and are spaced by a first width dimension or distance that is equal to a width of the base surface. The distal side surfaces 48 slope or taper toward each other in converging directions with increasing distance from the base surface 44, and define second width dimensions or distances that are less that the first width dimension. The illustrated embodiments of the housing 12 also include sloping shoulders 50 that extend from the portions defining the distal side surfaces 48 to form diverging shoulder surfaces 52 on opposite sides of the slot 32. Shoulders 50 may, for example also function as swing limiting bumpers.

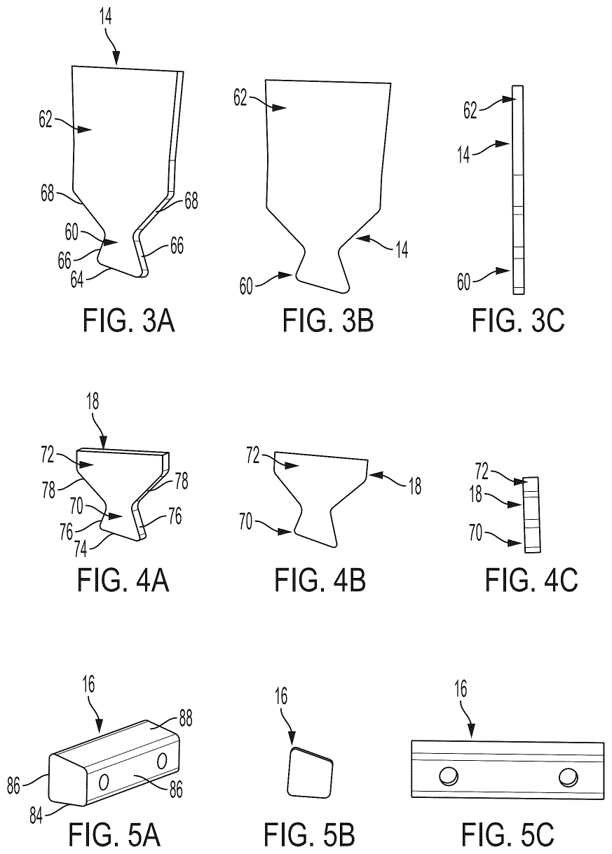

Referring also to FIGS. 3A-3C, the illustrated embodiments of the hammer elements 14 include a mount portion 60 that is configured to removably engage the housing 12 in the slot 32, and a head 62 that extends from the mount portion (and from the housing when the hammer element is mounted to the housing). The mount portion 60 has a shape that is complimentary to portions of the cross-sectional shape of the slot 32, so as to facilitate the entry and removal of the mount portion 60 into the slot from one of the ends of the housing 12, and constraint or engagement of the hammer element 14 in the housing to prevent the hammer element from separating from the housing (e.g., in a direction away from the slot and opposite the mount portion 30 of the housing) during operation of a hammermill. In the illustrated embodiments the mount portion 60 has an interlock shape defined by a base edge 64, and a pair of side edges 66 that extend from the base edge and converge or slope toward one another with increasing distance from the base edge. As described in greater detail below, the side edges 66 of the hammer elements 14 will engage the side surfaces 48 defining the slot 32 when the hammer elements are mounted to the housing 12. The illustrated embodiments of the hammer elements 14 also include a pair of shoulder edges 68 that extend from the side edges 66, and diverge or slope away from one another with increasing distance from the side edges. The shoulder edges 68 in these embodiments are configured to engage the shoulder surfaces 52 of the housing 12 when the hammer elements 14 are mounted to the housing 12. Hammer elements 14 can, for example, be cast or otherwise fabricated from materials such as steels and/or wear alloys.

Referring also to FIGS. 4A-4C, the illustrated embodiments of the spacers 18 include a tang or mount portion 70 that is configured to removably engage the housing 12 in the slot 32, and a spacing portion 72 that extends from the mount portion (and in the illustrated embodiments from the housing when the spacer is mounted to the housing). The spacing portion 72 has a height that is less than a height of the head 62 of the hammer elements 14 in the illustrated embodiments. Similar to the hammer elements 14, the mount portion 70 has a shape that is complimentary to portions of the cross-sectional shape of the slot 32, so as to facilitate the entry and removal of the mount portion into the slot from one of the ends of the housing 12, and constraint or engagement of the spacer 18 in the housing to prevent the spacer from separating from the housing during operation of a hammermill. In the illustrated embodiments the mount portion 70 has an interlock shape defined by a base edge 74, and a pair of side edges 76 that extend from the base edge and converge or slope toward one another with increasing distance from the base edge. As described in greater detail below, the side edges 76 of the spacers 18 will engage the side surfaces 48 of the housing 12 defining the slot 32 when the spacers are mounted to the housing. The illustrated embodiments of the spacer 18 also includes a pair of shoulder edges 78 that extend from the side edges 76, and diverge or slope away from one another with increasing distance from the side edges. The shoulder edges 78 in these embodiments are configured to engage the shoulder surfaces 52 of the housing 12 when the spacers are mounted to the housing 12. A thickness of the spacers 18 (e.g., a distance between the opposite major surfaces) is configured to define a spacing distance between the opposing major surfaces of the heads 62 of adjacent hammer elements 14 when the hammer elements are mounted to the housing 12.

Referring also to FIGS. 5A-5C, key 16 is shown as an elongated member that is configured to removably engage the housing 12, hammer elements 14 and spacers 18 in the slot 32. Key 16 has a cross-sectional shape (e.g., as shown in FIG. 5C) that is complimentary to portions of the cross-sectional shape of the slot 32, so as to facilitate the entry and removal of the key into the slot from one of the ends of the housing 12, and to force and secure the mount portions 60 of the hammer elements 14 and the mount portions 70 of the spacers 18 into engagement with the structure of the body defining the slot. The key 16 may have a cross sectional shape corresponding to a keyway opening between the base surface 44 defining the slot 32 and the mount portions 60 of the hammer elements 14 and the mount portions 70 of the spacers 18 when the hammer elements and spacers are positioned in the slot. In the illustrated embodiments the key 16 includes a base surface 84 configured to engage the base surface 44 of the slot 32, a pair of side surfaces 86 that extend from the base surface, and an upper surface 88 extending between the side surfaces. As shown for example in FIG. 1B, the upper surface 88 of the key 16 is configured to engage the base edges 64 of the hammer elements 14 and the base edges 74 of the spacers 18 when the hammer elements and spacers are mounted to the housing 12. As shown for example in FIGS. 1B, 3B, 4B and 5B, the upper surface of the key 16, and the base edges 64 of the hammer elements 14 and the base edges 74 of the spacers 18 are non-parallel to the base surface 44 of the slot 32 and the base surface 84 of the key 16 so as to facilitate wedging engagement of the key and the hammer elements and spacers.

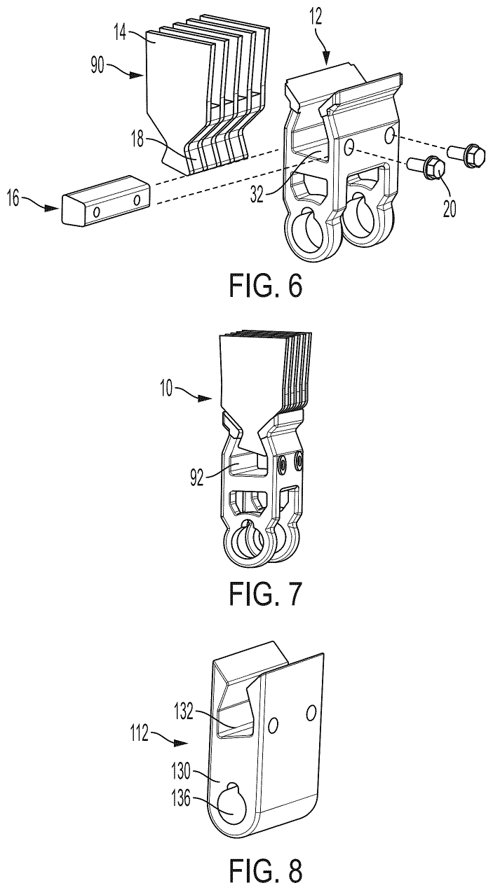

Methods for assembling the hammer assembly 10, and for replacing the hammer elements 14, can be described also with reference to FIGS. 6 and 7. One or more of the hammer elements 14, with one or more of the spacers 18 between hammer elements, can be mounted to the housing 12 by sliding the mount portions 60 of the hammer elements and the mount portions 70 of the spacers into the slot 32 from an end of the housing (e.g., along the slot axis 40). The group of one or more hammer elements 14 and one or more spacers 18 form a hammer cluster 90. In embodiments, the hammer element 14 and spacers 18 may be welded together or otherwise attached. As shown for example in FIG. 7, after the hammer elements 14 and spacers 18 are mounted to the housing 12, their respective mount portions 60 and 70 fill portions of the slot 32, and define a keyway 92 in remaining portions of the slot that has a cross-sectional shape complimentary to the cross-sectional shape of the key 16. The key 16 is then mounted to the housing 12 by sliding the key into the keyway 92 of the slot (e.g., along the slot axis 40). The key 16 engages the hammer elements 14 and spacers 18, and forces the hammer elements and spacers 18 into engagement with the housing 12. The key 16 thereby functions as a fastener to hold the hammer elements 14 and spacers 18 in the housing 12. Bolts 20, which can for example be threaded, can then be attached to the housing 12 and engage the key 16 to hold the key in the housing and further secure and fasten the hammer elements 14 and spacers 18 to the housing 12. Other embodiments include other approaches, such as for example cam locks, springs or force-open approaches to provide this functionality. Other embodiments additionally or alternatively include structures other than the keyway and key to secure the hammer elements 14 to the housing 12.

Following assembly and use of a key interlocking system in a hammermill, the hammers 14 can be removed from the housing 12 by loosening the bolts 20 and disengaging key 16. The hammers 14 and spacers 18 can then be slid out of the slot 32, and if desired replaced by new hammer elements and/or spacers. In embodiments, the above-described methods by which the hammer elements 14 and/or spacers 18 are mounted to and removed from the housing 12 can be done while the housing is attached to the hammermill drive structure. Other embodiments of hammer assemblies 10 with other structures and/or approaches for securing the hammer elements 14 to the housing 12 may not require bolts such as 20.

Embodiments of hammer 10 can also include one or more sensors such as that shown at 89 in FIG. 1C. The sensors 89 can be coupled to electronics off the hammer assembly 10 (e.g., by wired or wireless connections or approaches), and provide information representative of the operation of the hammer assembly. Such information may, for example, be used to determine the wear state of the hammer elements 14. Example of sensors 89 include accelerometers.

FIG. 8 is an illustration of a housing 112 in accordance with embodiments. As shown, a proximal mounting portion 130 of the housing 112 is a solid body having an aperture 136. Other than these differences, housing 112 can be substantially the same as or similar to the housing 12 described above.

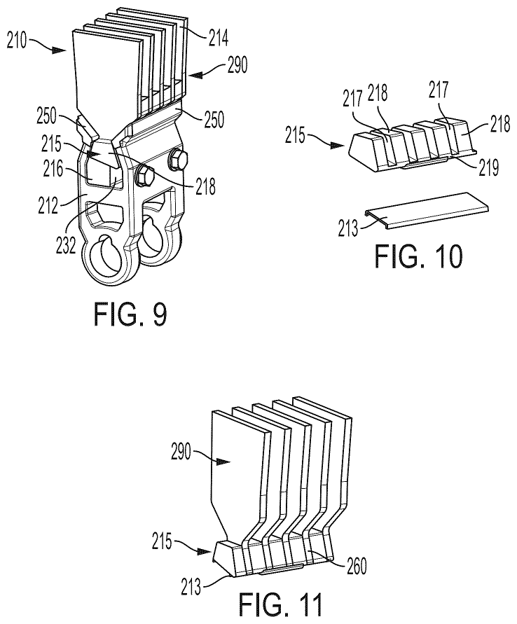

FIG. 9 is an illustration of a hammermill hammer assembly 210 in accordance with embodiments, including a one-piece or unitary spacer block 215 and a shim 213. FIG. 10 is an illustration of the spacer block 215 and shim 213. FIG. 11 is an illustration of a hammer cluster 290 of the hammer assembly 210. As shown, spacer block 215 includes a base portion 219 and a plurality of spacer portions 218 extending from the base portion. The spacer portions 218 define gaps or slots 217 between the spacer portions 218 that are configured to receive the mount portions 260 of the hammer elements 214. Widths of the spacer portions 218 thereby define the spacing between the hammer elements 214. As shown for example in FIG. 9, the spacer block 215 is configured to slide into the slot 232 of the housing 212 between the key 216 and the open side of the slot between the shoulders 250. Shim 213 may be located between the key 216 and the base portion 219 of the spacer block 215, and can be configured to provide improved hammer fit. Embodiments such as hammer assembly 210 may not need separate spacers 18 such as those described above in connection with hammer assembly 10. Alternatively or additionally, in embodiments the hammer elements 214 may be secured to the spacer block 215 by other structures or approaches, such as for example welding, adhesive or interference fits. Other than the differences described above, hammer 210 may be substantially the same as or similar to hammer 10 described above.

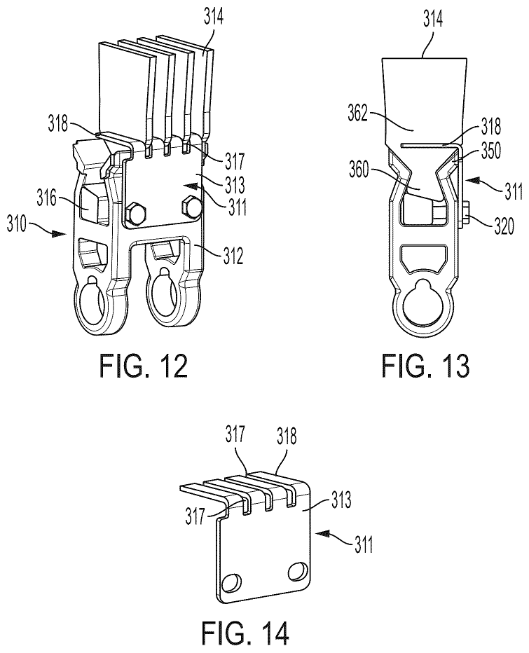

FIGS. 12 and 13 are illustrations of a hammermill hammer assembly 310 in accordance with embodiments that include an external spacer 311. FIG. 14 is an illustration of the external spacer 311. As shown, the spacer 311 includes a mounting plate 313 and a plurality of spacer fingers 318 extending from the mounting plate 313. The spacer fingers 318 define gaps or slots 317 between the spacer fingers that are configured to receive the heads 362 of the hammer elements 314. Widths of the spacer fingers 318 thereby define the spacing between the hammer elements 314. In the illustrated embodiments the mounting plate 313 is configured to be attached to a side of the housing 312, for example by bolts 320, and the spacer fingers 318 extend over the shoulders 350 of the housing 312. Embodiments such as hammer 310 may not need separate spacers 18 such as those described above in connection with hammer 10. Other than the differences described above, hammer assembly 310 may be substantially the same as or similar to hammer 10 described above.

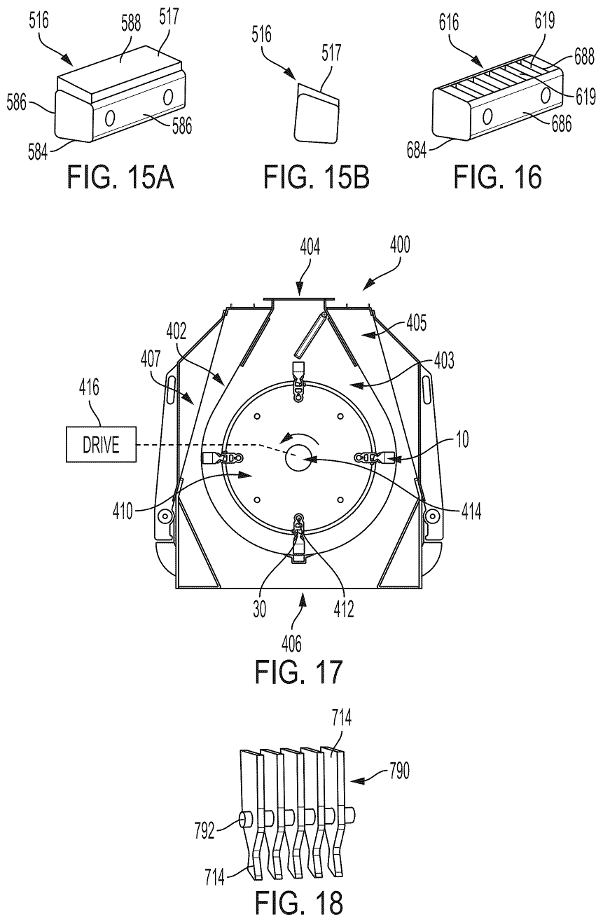

FIGS. 15A and 15B are illustrations of a key 516 in accordance with embodiments. As shown, key 516 includes a layer or area of compliant material 517 that defines a surface 588 configured to engage a hammer element. Additionally or alternatively, compliant material such as 517 may be located on one or more other surfaces of the key 516, such as for example the base surface 584. Examples of compliant material 517 include rubber (e.g., 80 durometer) and relatively soft aluminum. The compliant material 517 may accommodate tolerances of the hammer elements in the assembled hammer. Other than the differences described above, key 516 may be substantially the same as or similar to key 16 described above.

FIG. 16 is an illustration of a key 616 in accordance with embodiments. As shown, key 616 includes one or more recesses 619 (a plurality are shown) in the surface 688. Recesses 619 are configured (e.g., sized, shaped and located) to receive and seat the mount portions 60 of the hammer elements 14. Other than the differences described above, key 616 may be substantially the same as or similar to key 16 described above.

FIG. 18 is an illustration of a cluster 790 of hammer elements 714 in accordance with embodiments. As shown, a rod 792 extends through an aperture in each of the hammer elements 714. The rod 792 can align the hammer elements 714, and facilitate assembly of a hammer including the cluster 790. Other than the differences described above, cluster 790 may be substantially the same as or similar to the cluster 90 of hammer elements described above.

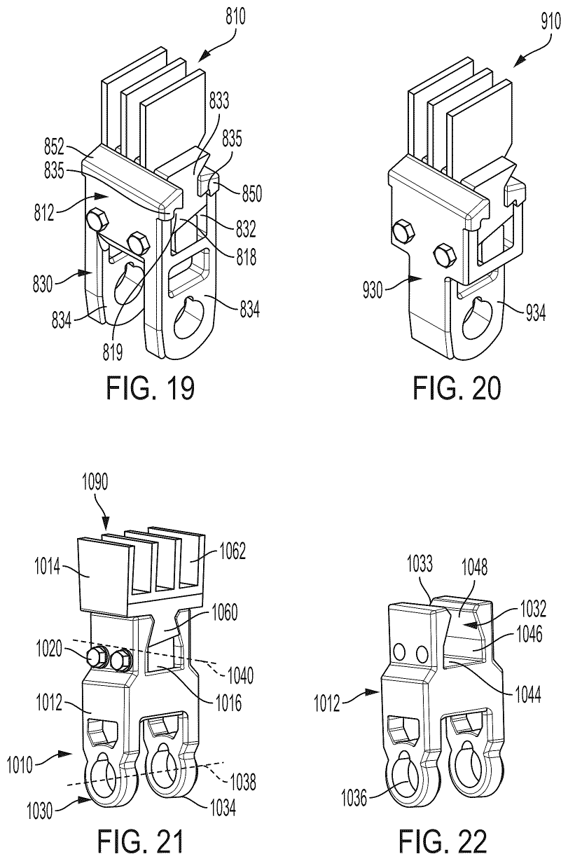

FIG. 19 is an illustration of a hammermill hammer assembly 810 in accordance with embodiments. As shown, upper portions of the housing 812 defining slot 832 includes recesses 835 on the opposite sides of the opening 833. Spacers 818 include tabs 819 that extend into the recesses 835. The shoulders 850 of the housing 812 include shoulder surfaces 852 that slope downwardly and away from the opening 833. Other than these and other differences shown in FIG. 19, hammer assembly 810 can be substantially the same as or similar to hammer assembly 10 described above.

FIG. 20 is an illustration of a hammermill hammer assembly 910 in accordance with embodiments. As shown, hammer assembly 910 includes a mount portion 930 including a single connecting link 934. Other than these and other differences shown in FIG. 20, hammer assembly 910 can be substantially the same as or similar to hammer assembly 910 described above (which includes two links 834).

FIG. 21 is an illustration of a hammermill hammer assembly 1010 in accordance with embodiments. FIG. 22 is an illustration of a housing 1012 for embodiments of the hammermill hammer assembly 1010. As shown, the hammer assembly 1010 includes a housing 1012, a cluster 1090 of hammer elements 1014 and a key 1016 mounted to the housing 1012. The housing 1012 includes a body or structure defining a mount portion 1030 on a proximal end and a slot 1032 on a distal end. Mount portion 1030 is configured for attachment of the housing 1012 to a rod, disk, rotor plate or other drive structure of a hammermill as shown, for example, in FIG. 17. In particular, the mount portion 1030 is configured to be mounted to the hammermill drive structure in such a manner that the hammer assembly 1010 can swing, for example rotate or pivot, with respect to the drive structure when the hammermill is in operation. The mount portion 1030 can be configured to be mounted for swinging motion to any known or otherwise conventional drive structures, and in the illustrated embodiments includes one or more connecting legs or links 1034 extending from the portion defining the slot 1032, and apertures 1036 through end portions of the links (two links are shown for purposes of example in FIG. 21. As shown, the apertures 1036 define a rotational axis 1038 about which the hammer assembly 1010 can swing during operation of the hammermill. The links 1034 extend from the opposite ends of the portion of the body defining the slot 1032 in the embodiments shown in FIG. 21. In other embodiments (not shown), the links extend from portions of the body defining the slot 1032 at locations spaced toward the center of the body from the opposite ends.

The slot 1032 extends from and between the opposite sides of the body forming the mount portion 1030, and has an opening 1033. In the illustrated embodiment the slot 1032 is open at both opposite sides of the housing 1012. In other embodiments (not shown), the slot 1032 may open in only one of the sides of the housing 1012. The slot 1032 is elongated in the illustrated embodiments, and defines a slot axis 1040. Slot axis 1040 is generally perpendicular to the rotational axis 1038 in the illustrated embodiments. Slot 1032 is configured to removably receive the cluster 1090 of hammer elements 1014 from one or both ends of the housing 1012, for example in a direction that is generally tangential to the rotational axis 1038, and to retain the cluster of hammer elements in the housing. In the illustrated embodiments, the mount portion 1030 is configured to prevent movement of the cluster 1090 of hammer elements 1014 from the housing 1012 in the distal or radial direction, away from the mounting portion 1030. Consistent with this functionality, the illustrated embodiments of the mount portion 1030 defines a slot 1032 having an interlocking cross-sectional structure and/or shape. The slot 1032 is defined by surfaces in the housing 1012 including a base surface 1044, a pair of relatively proximal end surfaces 1046 that extend from opposite ends of the base surface, and a pair of relatively distal end surfaces 1048 that extend from the end surfaces 1046 toward the opening 1033. In the illustrated embodiments the proximal end surfaces 1046 extend generally perpendicularly from the base surface 1044, and are spaced by a first width dimension or distance that is equal to a width of the base surface. The distal end surfaces 1048 slope or taper toward each other in converging directions with increasing distance from the base surface 1044, and define second width dimensions or distances that are less that the first width dimension. Although shown with a cluster 1090 of hammer elements 1014 in FIGS. 21 and 22, other embodiments may include other components such as one or more hammer elements such as 14 and/or one or more spacers such as 18 described above.

The cluster 1090 of hammer elements 1014 includes a mount portion 1060 that is configured to removably engage the housing 1012 in the slot 1032, and a head 1062 that extends from the mount portion (and from the housing when the hammer element is mounted to the housing). The mount portion 1060 has a shape that is complimentary to portions of the cross-sectional shape of the slot 1032, so as to facilitate the entry and removal of the mount portion 1060 into the slot from one of the sides of the housing 1012 (e.g., in a direction generally parallel to the axis 1040 and generally tangential to the axis 1038) and to prevent the cluster 1090 of hammer elements 1014 from separating from the housing 1012 away from the slot and opposite the mount portion 1030 of the housing during operation of a hammermill. In the illustrated embodiments the mount portion 1060 has an interlock shape defined by a base edge, and a pair of end edges that extend from the base edge and converge or slope toward one another with increasing distance from the base edge. The end edges of the mount portion 1030 will engage the end surfaces 1048 defining the slot 1032 when the cluster of hammer elements is mounted to the housing 1012.

Key 1016 is shown as an elongated member that is configured to removably engage the housing 1012 and cluster 1090 of hammer elements 1014 in the slot 1032. Key 1016 has a cross-sectional shape that is complimentary to portions of the cross-sectional shape of the slot 1032, so as to facilitate the entry and removal of the key into the slot from one of the sides of the housing 1012, and to force and secure the mount portion 1060 of the cluster 1090 of hammer elements 1014 into engagement with the structure of the body defining the slot. The key 1016 may have a cross sectional shape corresponding to a keyway opening between the base surface 1044 defining the slot 1032 and the mount portion 1060 of the cluster 1090 of hammer elements 1014 when the cluster of hammer elements is positioned in the slot. In the illustrated embodiments the key 1016 includes a base surface configured to engage the base surface 1044 of the slot 1032, a pair of end surfaces that extend from the base surface, and an upper surface extending between the end surfaces. The upper surface of the key 1016 is configured to engage the base edge of the mount portion 1060 of the cluster 1090 of hammer elements 1014 when the cluster of hammer elements is mounted to the housing 1012. In the illustrated embodiments the upper surface of the key 1016, and the base edge of the mount portion 1060 of the cluster 1090 of hammer elements 1014 are non-parallel to the base surface 1044 of the slot 1032 and the base surface of the key 1016 so as to facilitate wedging engagement of the key and the cluster of hammer elements. Fasteners such as for example the bolts 1020 shown in the illustrated embodiments can be attached to the housing 1012 and engage the key 1016 to hold the key in the housing and further secure and fasten the cluster 1090 of hammer elements 1014 to the housing. Other than the structural differences associated with the generally “tangential” mounting approach shown described herein, the structures of the hammer assembly 1010 can be similar to those of the other hammer assemblies described herein having the “axial” mounting approach.

FIG. 17 is a diagrammatic illustration of an exemplary hammermill 400 including a plurality of hammer assemblies such as 10 in accordance with embodiments. As shown, the hammermill 400 includes an inlet 404 and a discharge or outlet 406. The inlet 404 opens into a classifying screen 402 that defines and surrounds at least portions of a grinding chamber 403 within a housing 405. The illustrated embodiments include a door 407 that can provide access to the grinding chamber 403. The mount portions 30 of the hammer assemblies 10 are pivotally mounted to a rotor plate 410 by a round rod 412 extending between rotor plates to enable the hammer assemblies to swing during rotation of the rotor plate. The rotor plate 410 is mounted to a rotor shaft 414, and is driven by a drive 416 such as an electric motor. During operation of the hammermill 400, the rotor plate 410 is rotated in the grinding chamber 403, while material to be crushed (not shown) enters the grinding chamber through the inlet 404. The rotation of the rotor plate 410 causes the hammer assemblies 10 to rotate in the grinding chamber 403 with the rotation of the rotor plate 410, and to swing on the rotor plate, thereby crushing the material as moves through the grinding chamber and classifying screen 402 from the inlet 404 to the outlet 406. Although hammermill 400 is shown for purposes of example, hammer assemblies such as 10 described herein can be incorporated into other conventional or otherwise known hammermills.

The invention of this application has been described above both generically and with regard to specific embodiments. It will be apparent to those skilled in the art that various modifications and variations can be made in the embodiments without departing from the scope of the disclosure. For example, other structures and/or approaches may be used to secure hammer elements to the housing in other embodiments (e.g., alternatively and/or additionally to the use of a keyway and key). Features described in connection with one or more embodiments can be incorporated into other embodiments. Thus, it is intended that the embodiments cover the modifications and variations of this invention provided they come within the scope of the appended claims and their equivalents.

What is claimed is:

1. A hammer assembly for a hammermill, comprising:
a housing, including:
a mount portion configured for attachment to a drive; and
a slot;
one or more hammer elements, each including:
a mount portion configured to removably engage the slot; and
a head; and
one or more fasteners, the one or more fasteners releasably securing the one or more hammer elements to the mount portion of the housing.

2. The hammer assembly of claim 1, wherein:
the mount portion of the housing defines a swing axis; and
the slot defines a longitudinal axis with respect to the swing axis, and wherein the longitudinal axis is optionally generally perpendicular or parallel to the swing axis.

3. The hammer assembly of claim 2, wherein the mount portion of the housing comprises:
one or more links; and
an aperture in each of the one or more links.

4. The hammer assembly of claim 3, comprising a plurality of the links.

5. The hammer assembly of claim 4, wherein:
the slot is defined by a length; and
the plurality of links define a length that is less than or equal to the length of the slot.

6. The hammer assembly of claim 1, wherein the one or more fasteners engages the mount portion of the housing and the mount portion of each of the one or more hammer elements.

7. The hammer assembly of claim 6, wherein the one or more fasteners includes a key in the slot.

8. The hammer assembly of claim 7, wherein the housing, hammer elements and key are configured such that the key can slide into the slot in a direction parallel to a longitudinal axis of the slot.

9. The hammer assembly of claim 7, wherein:
the slot is defined by a cross-sectional shape including:
first width dimension at a first location with respect to the mount portion; and
a second width dimension that is less than the first width dimension at a second location opposite the first location from the mount portion; and
the mount portion of each hammer element defines a cross-sectional shape that is complimentary to the cross-sectional shape of the slot, facilitating slideable insertion and the removable engagement of the mount portion of the hammer element in the slot.

10. The hammer assembly of claim 9, wherein the cross-sectional shape of the slot and the cross-sectional shape of the mount portion of each hammer element are interlocking shaped.

11. The hammer assembly of claim 10, wherein:
the slot includes a base surface;
each hammer element includes a base edge; and
the key is located between the base surface of the slot and the base edge of each hammer element.

12. The hammer assembly of claim 11, wherein:
the key includes:
a base surface that engages the base surface of the slot;
an engaging surface opposite the base surface, and wherein the engaging surface is non-parallel to the base surface.

13. The hammer assembly of claim 12, wherein the base surface of each hammer element is parallel to and engages the engaging surface of the key.

14. The hammer assembly of claim 12, further comprising a shim between the engaging surface of the key and the base sedge of each hammer element.

15. The hammer assembly of claim 6, wherein the one or more fasteners includes one or more fasteners extending through the mount portion of the housing and engaging the key.

16. The hammer assembly of claim 15, wherein at least one of the one or more fasteners extending through the mount portion comprises a threaded fastener.

17. The hammer assembly of claim 1, wherein the one or more fasteners includes one or more fasteners extending through the mount portion.

18. The hammer assembly of claim 17, wherein at least one of the one or more fasteners extending through a side of the mount portion comprises a threaded fastener.

19. A hammermill including one or more hammer assemblies in accordance with claim 1.

20. A hammermill hammer element configured to be removably mounted to a housing including a slot defining a cross sectional shape, the hammermill hammer element comprising:
a mounting portion having a cross sectional shape that is complimentary to the cross sectional shape of the slot of the housing, and configured to slide into the slot and to interlock with the housing; and
a head extending from the mounting portion.
